(19) United States
(12) Patent Application Publication
(10) Pub. No.: US 2026/0227885 A1
(43) Pub. Date: Aug. 6, 2026

(54) AI-BASED PERSONALIZED OPT-IN AND SKIP INTERFACE FOR ELECTRONIC DEVICE AND APPLICATION SETUP

(71) Applicant: MOTOROLA MOBILITY LLC, WILMINGTON, DE (US)

(72) Inventors: AMIT KUMAR AGRAWAL, BANGALORE (IN); KRISHNAN RAGHAVAN, BANGALORE (IN); NAKUL PATEL, NAGPUR (IN)

(21) Appl. No.: 19/044,824

(22) Filed: Feb. 4, 2025

(51) Int. Cl. G06F 3/0482; G06F 9/451; G06F 11/34

(52) U.S. Cl. CPC G06F 3/0482; G06F 9/451; G06F 11/3438

(57) ABSTRACT

An electronic device detects user engagement with an opt-in selection (OIS) user interface (UI) that includes selectable options and request for action(s) configured to encourage a user to accept the pre-selected content in response to the request for action. In response to detecting a request for action within the OIS UI that triggers automatic selection of the selectable option, a processor of the electronic device causes the electronic device to analyze all content of the OIS UI to identify whether any one of the options are pre-selected and whether the call to action is potentially misleading. The processor causes the electronic device to: generate a modified OIS UI presenting at least one clearly visible option for bypassing a selection of the request for action; and render and present the modified OIS UI to enable an option for moving past the OIS UI without completing the request for action.

### BACKGROUND

### 1. Technical Field

The present disclosure relates generally to electronic devices that support installation and setup of applications on the device, and more particularly to electronic devices that presents user selectable options in a user interface (UI).

### 2. Description of the Related Art

Electronic communication devices such as smartphones and laptops enable users to use various productivity tools and applications to perform everyday tasks. During configuration of the devices and installation of applications on the device, the electronic communication devices can present one or more user interfaces (UIs) to enable a user to interact with and select options for the device configuration and/or application installation. One or more selectable options can be presented to enable the users to provide input to complete the configuration/installation.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a functional block diagram of example components of an electronic device in a communication environment and having hardware and software components that enable the features of the present disclosure to be advantageously implemented, in accordance with one or more embodiments;

FIG. 1B is an additional block diagram representation of the electronic device of FIG. 1A presenting additional components, including components for wireless communications with other devices, in accordance with one or more embodiments;

FIG. 2 illustrates a block diagram presenting components of the electronic device that configure the electronic device to perform dynamic modification of an opt-in selection user interface (UI) to enable informed user selection and/or facilitate bypass of presented options, in accordance with one or more embodiments;

FIG. 3 illustrates a software platform diagram of an artificial intelligence (AI) operating system (OS) of the electronic device of FIGS. 1A and 2, in accordance with one or more embodiments;

FIG. 4 presents a block diagram illustration of an application and services opt-in assistance (ASOA) module for facilitating user understanding and interfacing with an opt-in selection UI, in accordance with one or more embodiments;

FIGS. 5A-5B presents a sequence of opt-in selection UIs illustrating operation of the ASOA module to modify an opt-in selection UI by adding additional descriptive content and selectable skip option to facilitate user interfacing without inadvertent opt-in of pre-selected options, in accordance with one or more embodiments;

FIGS. 6A-6C presents a sequence of opt-in selection UIs illustrating modification and/or replacement of an initial opt-in selection UI having hidden content and a vague request for action with a modified opt-in selection UI that presents a clearer request for action and access to view the hidden content, in accordance with one or more embodiments;

FIGS. 7A-7C presents another sequence of opt-in selection UIs illustrating modification and/or replacement of an initial opt-in selection UI that includes multiple pages of content including some hidden pages with an example modified opt-in selection UI presenting all of the pages via an overlay format, in accordance with one or more embodiments;

FIG. 8 is a flow diagram presenting a computer-implement method for generating and presenting a modified OIS UI to facilitate user engagement therewith and prevent inadvertent opt-in of pre-selected options due to restrictive and/or deceptive options in an original OIS UI, in accordance with one or more embodiments;

FIG. 9 is a flow diagram presenting a computer-implement method for using a plurality of stored parameters to determine risk associated with potentially misleading or confusing information included in the presented OIS UI, in accordance with one or more embodiments; and

FIG. 10 is a flow diagram presenting a computer-implement method for modifying an OIS UI based on a determined risk level, in accordance with one or more embodiments.

### DETAILED DESCRIPTION

According to aspects of the present disclosure, an electronic device, a method and a computer program product provide various techniques for autonomously modifying an opt-in selection (OIS) user interface (UI) to provide additional descriptive content and/or facilitate user engagement with and bypass of the OIS UI. An original (device or application generated) OIS UI includes content and request for action(s) or call to actions (CTA) where automatic selection of one or more specific features, services, and applications is preconfigured into the OIS UI to encourage a user to accept the pre-selected content in response to the request for action. Without carefully analyzing the pre-selections, a user may inadvertently opt-in to an application or service that the user does not wish to have. However, the original OIS UI typically presents only a CTA for the user to move on with the selections or requires the user manually deselect specific ones of the pre-selected options.

Often, the original OIS UIs are designed to mislead or confuse the user into accepting the request for action and/or one or more of the specific pre-selected features, services, and/or applications via the automatic selection, without fully informing the user directly or indirectly. Examples of the deception that can be utilized with these original OIS UIs can include hiding information by using multiple pages, presenting information with preferred selectable options haivng more visibility than other non-preferred selectable options, and presenting a large volume of information in a single block, all with the intention of discouraging a user take the time to review the information, thus encouraging the user to accept the automatic selection. Often, the installed or accepted features/service/applications may not comply with established safeguard standards, such as user preferences, peer user inputs, and policy compliance requirements.

The embodiments disclosed herein address and overcome the aforementioned issues/problems/limitations by dynamically modifying the OIS UI that is presented to the user to enable the user to be more informed of the information being presented by the OIS UI and to provide the user with additional options for bypassing the OIS UI without making any selections or de-selections. Some embodiments include introducing additional selectable options, reorganizing the information being presented so that the information is more readable, and dynamically unselecting the automatic selection(s), among others. The modification of the OIS UI can be performed using an artificial intelligence (AI) engine/model. The AI engine/model can be trained to analyze the content of the OIS UI using one or more natual language processing (NLP) analysis, contextual analysis, and semantic analysis.

By analyzing the OIS UI with automatic pre-selections of options, the disclosure enables device modification of the OIS UI to present the content in a more user customizable and understandable way. The disclosure provides techniques that enable the user to be more informed of the presented content and of other selectable options, instead of inadvertently accepting certain content with the automatic selection that the user does not necessarily wish to select. The techniques further include using artificial intelligence (AI) to analyze the OIS UI to determine whether the request for action or one or more of the specific features, services, and/or applications is inconsistent with one or more safeguard standards. The techniques may further include using the AI to determine whether the request for action or one or more of the specific optional features, services, and/or applications (OFSAs) is clearly presented to the user with clear options to refuse to opt-in, thus preventing inadvertent opt-in of/to these OFSAs.

In accordance with one or more embodiments, an electronic device includes at least one input device, and at least one output device, including a display. The electronic device has a memory having stored thereon a device and application and services opt-in assistance (ASOA) module. The electronic device includes a processor communicatively coupled to the at least one input device, the at least one output device, and the memory. The processor is configured to cause the electronic device to: detect user engagement with one or more opt-in selection (OIS) user interfaces (UI) presenting at least one selectable choice for opting in to specific optional features, services, and/or applications (OFSAs); in response to detecting a request for action within the OIS UI that triggers automatic selection of at least one of the specific OFSAs: (i) analyze all content of the OIS UI including hidden content to identify whether any one of the OFSAs are selected; (ii) generate a modified OIS UI comprising at least one clearly visible option for bypassing a selection of the request for action; and (iii) render and present the modified OIS UI on the display to inform a user and enable an option for moving past the OIS UI without completing the request for action.

In accordance with one or more embodiments, a method is provided for detecting user engagement with one or more OIS UI presenting at least one selectable choice for opting in to specific optional features, services, and/or applications (OFSAs). In response to detecting a request for action within the OIS UI that triggers automatic selection of at least one of the specific OFSAs: (i) analyzing all content of the OIS UI including hidden content to identify whether any one of the OFSAs are selected; (ii) generating a modified OIS UI comprising at least one clearly visible option for bypassing a selection of the request for action; and (iii) rendering and presenting the modified OIS UI on the display to inform a user and enable an option for moving past the OIS UI without completing the request for action.

Further embodiments provide a computer program product that includes: a non-transitory computer readable medium; and program code on the computer readable medium that, when processed by a processor of an electronic device, configures the processor and/or the electronic device to perform functions of the above-described method.

The above contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent within the following detailed description.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized, and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but no other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

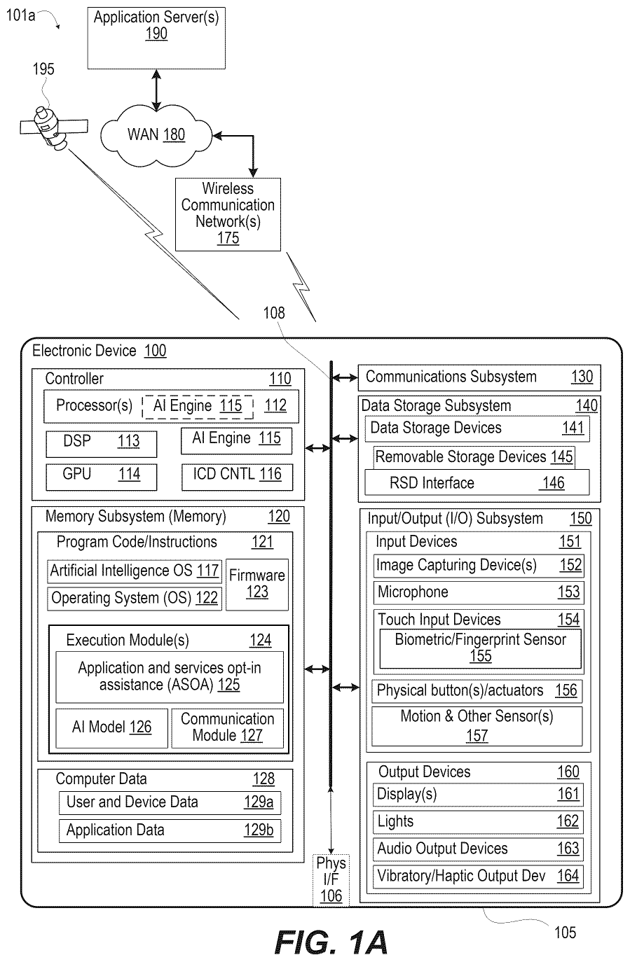

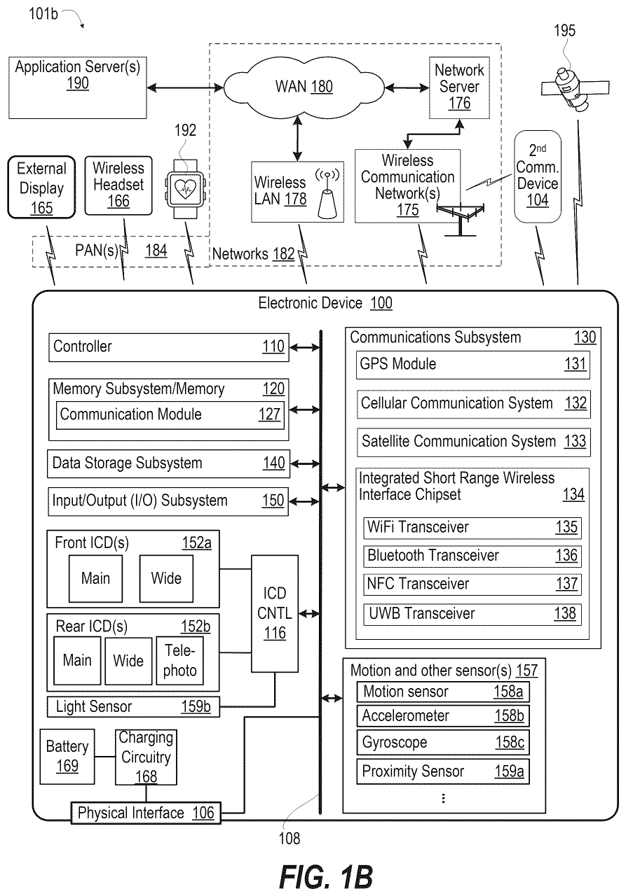

Those of ordinary skill in the art will appreciate that the hardware components and basic configuration depicted in the following figures may vary. For example, the illustrative components within electronic device 100 (FIG. 1A-1B) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural, functional, operational, or otherwise) on the described embodiments.

Referring now to the figures and beginning with FIG. 1A, there is illustrated a block diagram of an example electronic device 100 in communication environment 101a and having hardware and software components, which enable the features of the present disclosure to be advantageously implemented, in accordance with one or more embodiments. Examples of electronic device 100 can include, but are not limited to, mobile devices, a notebook computer, a mobile phone, a smart phone, a digital camera with enhanced processing capabilities, a smart watch, a tablet computer, and other types of electronic devices.

Electronic device 100 generally includes controller 110, memory (or memory subsystem) 120, communication subsystem 130, data storage subsystem 140, input/output subsystem 150, all contained within or extended from an exterior surface of device housing 105. Controller 110 is shown communicatively connected/coupled via system interlink 108 with each of the subsystems 120, 130, 140, and 150, and is directly or indirectly connected with the individual components within each subsystem 120, 130, 140, and 150. System interlink 108 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components.

Controller 110 includes processor 112, which includes one or more central processing units (CPUs) or data processors. Processor 112 performs many of the features of controller 110 and references to features performed by controller 110 can be interchangeably referred to herein as features of processor 112, and vice-versa. In some embodiments, the various functions associated with controller 110 are integrated into processor 112, and accordingly, references made herein to controller and/or processor are understood to refer to one or both components as providing a single management component within the electronic device 100. For simplicity in describing the features of the electronic device 100, the operational functions provided by one or more of operational components within controller 110, including those provided by processor 112 are collectively described as being performed by controller 110. Collectively, components integrated within controller 110 support computing, classifying, processing, transmitting and receiving of data and information, and presenting of graphical and photographic images within a display.

As illustrated, controller 110 can also include one or more digital signal processors 113 graphics processing units (GPUs) 114, artificial intelligence (AI) engine 115, and image capturing device (ICD) controller 116. In some embodiments, the functionality of each of these additional processing components can be integrated with processor(s) 112. For example, processor 112 can, in some embodiments, include dedicated AI engine 115 and image signal processors (ISPs) (not shown). Processor 112 can further include other processors such as auxiliary processor(s) that may act as a low power consumption, always-on sensor hub for physical sensors.

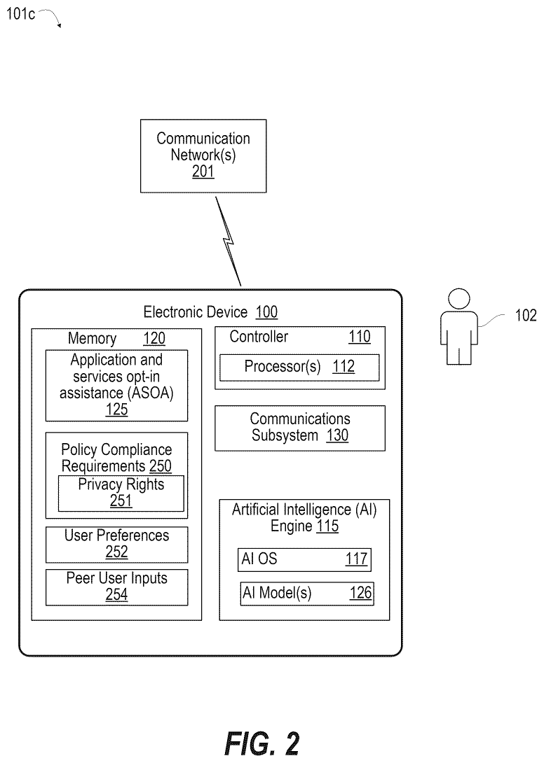

Controller 110 manages, and in some instances directly controls, the various functions and/or operations of electronic device 100. These functions and/or operations include, but are not limited to including, application data processing, communication, location and navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic. Controller 110 can, in some embodiments, also include a hardware acceleration (HA) unit, which can establish direct memory access (DMA) sessions to route network traffic to various elements within electronic device 100 without direct involvement from processor 112 and/or a device operating system 122. Operating system 122 may include or be augmented by device AI operating system (OS) 117 that is described below with regard to FIG. 2.

Memory subsystem (or memory) 120 may include a combination of volatile and non-volatile memory, such as random-access memory (RAM) and read-only memory (ROM). Memory subsystem 120 stores instruction or program code 121 for execution by processor 112 to configure processor 112 (and more generally electronic device 100) to provide the operational functions and features described herein. Instructions/program code 121 (or program code 121 for short) includes instructions for an operating system (OS) 122, firmware 123, such as basic input/output system (BIOS) or Uniform Extensible Firmware Interface (UEFI). Program code 121 includes execution module(s) 124 that collectively provides the various features of the disclosure. Execution module(s) 124 include, without limitation, application and services opt-in assistance (ASOA) module 125, which provides the features and operating functionality of the disclosed embodiments when the corresponding program instructions of ASOA module 125 are processed by/within processor 112/controller 110.

Execution modules 124 further includes AI model(s) 126. In accordance with one or more embodiments, processor 112 can utilize AI models 126 to provide AI functionality of processor-integrated AI engines 115. In other embodiments, AI models 126 are directly utilized by AI engine 115. In accordance with one or more embodiments, AI model 126 is integrated as a sub-module within ASOA module 125 and is trained to support the AI features of ASOA module 125. AI model(s) 126 may include an artificial neural network, a decision tree, a support vector machine, Hidden Markov model, linear regression, logistic regression, Bayesian networks, and so forth. AI model(s) 126 can be individually trained to perform specific tasks and can be arranged in different sets of AI models to generate different types of output. Training of AI model(s) 126 is the process by which AI models are trained to perform specific tasks or achieve certain objectives. The training involves providing the model with a large amount of data and allowing the model to learn from patterns and relationships within that data.

Each of the above-introduced module(s) and/or application(s) provides program instructions/code that are processed by processor 112 and which configures processor 112 (and/or controller 110) and/or other operational components of electronic device 100 to cause the electronic device 100 to perform specific operations and functions, as described herein. Descriptive names assigned to these modules add no functionality and are provided solely to assist in identifying the underlying features performed by processing the different modules. For example, ASOA module 125 can include program instructions that cause or configure processor 112 to cause electronic device 100 to analyze the OIS UI including its content and the request for action to determine and identify any potentially misleading or confusing information and to modify the OIS UI to reduce the risk of the potentially misleading or confusing information causing inadvertent selection for installation of applications and/or opting-in to services/agreements by the user 102 of the electronic device 100. Other features provided by ASOA module 125 are described in further detail throughout this disclosure.

Program code 121 can further include instructions/code for other applications (not shown) providing different features of/within electronic device 100. In accordance with one or more embodiments, program code 121 may be integrated into a distinct chipset or hardware module as firmware that operates separately from other executable program code. Portions of program code 121 may be incorporated into different hardware components that operate in a distributed or collaborative manner.

Memory subsystem 120 also includes computer data 128. During execution of program code 121, processor 112 may access, use, generate, modify, store, or communicate computer data 128, such as user and device data 129a and application data 129b. Computer data 128 may incorporate “data” that originated as raw, real-world “analog” information that consists of basic facts and figures. Computer data 128 includes different forms of data, such as numerical data, images, coding, notes, and financial data, as well as data presenting video, graphics, text, and images. Computer data 128 may originate at electronic device 100 or may be retrieved from a remote device via communications subsystem 130. Electronic device 100 may store, modify, present, or transmit computer data 128.

Communications subsystem 130 includes various components that enable electronic device 100 to communicate with external communication networks and other devices, such as application server(s) 190, etc., via communications subsystem 130. In accordance with one or more embodiments, communication module 127 presented within program code 121 includes instructions supporting the use of communications subsystem 130 to establish communication interfaces enabling communication by electronic device 100 with these external networks and devices.

Data storage subsystem 140 of electronic device 100 includes data storage device(s) 141. Controller 110 is communicatively connected, via system interlink 108, to data storage device(s) 141. Data storage subsystem 140 provides stored versions of program code 121 and computer data 128 on nonvolatile storage that is accessible by controller 110. The program code 121 can be loaded into memory 120 for execution/processing by controller 110. In accordance with one or more embodiments, data storage device(s) 141 can include hard disk drives (HDDs), optical disk drives, and/or solid-state drives (SSDs), etc.

Data storage subsystem 140 of electronic device 100 can include removable storage device(s) (RSD(s)) 145, which is received in RSD interface 146. Controller 110 is communicatively connected to RSD 145, via system interlink 108 through RSD interface 146. In accordance with one or more embodiments, RSD 145 is a non-transitory computer program product or computer readable storage device that stores program code and associated data, including a copy of ASOA module 125 and AI model(s) 126, which may be executed by a processor associated with a user device, such as electronic device 100. Controller 110 can access data storage device(s) 141 or RSD(s) 145 to provision electronic device 100 with stored program code 121 and computer data 128 that, when executed/processed by processor 112, the program code configures processor 112 and/or more generally electronic device 100, to provide the various functions described herein. For example, in response to the electronic device 100 detecting that the user is engaging with one or more OIS UI and in response to determining that there exists a potentially misleading or confusing information associated with an automatic selection, a variation of the content of the OIS UI can be generated and stored in the data storage device(s) 141 of the electronic device 100. In accordance with one or more embodiments, the data storage device(s) 141 can also store information related to the OIS UI and/or an application associated with the OIS UI identifying the potentially misleading or confusing information used so that the information can be shared with other users and/or other applications interested in preventing such potentially misleading or confusing information.

I/O subsystem 150 includes input devices 151 such as, but not limited to, image capturing device(s) (ICDs) 152, microphone 153, and touch input devices 154 (e.g., touch screens, keys, or buttons) for use by user 102 to interface with electronic device 100. Touch input devices 154 can include a biometric/fingerprint sensor 155 for biometric input. Biometric/fingerprint sensor 155 can be used to read/receive biometric data, such as fingerprints, to identify or authenticate a user. In some embodiments, the biometric sensor 155 can supplement an ICD (camera), which captures images for user detection/identification via facial recognition.

Input devices 151 may include physical buttons/actuators 156 that can be located on a periphery of the device housing 105. Physical buttons/actuators 156 may provide controls for volume, power, and ICDs 152. Microphone 153 can also be referred to as an audio input device. In some embodiments, microphone 153 may be used for identifying a user via voiceprint, voice recognition, and/or other suitable techniques. Input devices 151 can also include one or more motion or other sensor(s) 157, which are further defined in the FIG. 1B description which.

With reference to FIG. 1B, as illustrated, motion and other sensor(s) 157 of electronic device 100 include, but are not limited to, one or more motion sensor(s) 158a, one or more accelerometers 158b, one or more gyroscopes 158c, and proximity sensor 159a, etc. Motion sensor(s) 158a detect movement of electronic device 100 and provide motion data to processor 112 indicating the spatial orientation, position and movement of electronic device 100. Accelerometers 158b measure linear acceleration of movement of electronic device 100 in multiple axes (X, Y and Z). For example, accelerometers 158b can include three accelerometers, where one accelerometer measures linear acceleration in the X axis, one accelerometer measures linear acceleration in the Y axis, and one accelerometer measures linear acceleration in the Z axis. Accelerometers 158b can be used to calculate the orientation/position of electronic device 100 relative to the earth and can also be referred to as a gravity sensor. Gyroscope 158c measures rotation or angular rotational velocity of electronic device 100. Proximity sensor 159a senses the presence of nearby objects. In one embodiment, proximity sensor 159a can be an infrared (IR) sensor that detects the presence of a nearby object, such as when electronic device 100 is in a pocket of a user. Electronic device 100 can also include one or more light sensors 159b, which detects the luminance and/or intensity (i.e., the amount) of ambient light surrounding the electronic device 100.

Referring again to FIG. 1A, I/O subsystem 150 includes output devices 160 such as, but not limited to, display(s) 161, lights 162, audio output devices 163, and vibratory and/or haptic output devices 164. In accordance with one or more embodiments, electronic device 100 includes an integrated display 161 which incorporates a tactile, touch screen interface that can receive user's tactile/touch input. As a touch screen device, integrated display 161 allows a user to provide input to and/or to control electronic device 100 by touching features within a user interface presented on integrated display 161. Tactile, touch screen interface (154) can be utilized as an input device. The touch screen interface (154) can include one or more virtual buttons or selectable affordances. In accordance with one or more embodiments, when a user applies a finger or stylus on the touch screen interface (154) in the region demarked by the virtual button, the touch of the region causes the processor 112 to execute code to implement a function associated with the virtual button. In some implementations, integrated display 161 is integrated into a front surface of electronic device housing 105 along with front image capturing devices (not specifically shown), while the higher quality ICDs are located on a rear surface of device housing 105. Other embodiments provide multiple integrated displays within electronic device 100 and references to display(s) 161 are assumed to refer to one or all of these multiple integrated displays.

Vibration/haptic output device 164 can cause electronic device 100 to vibrate or shake when activated. Vibration/haptic output device 164 can be activated during an incoming call or message in order to provide an alert or notification to a user of electronic device 100. In accordance with one or more embodiments, integrated display 161, audio output devices (or speakers) 163, and vibration/haptic device 164 can generally and collectively be referred to as output devices.

With reference again to FIG. 1B and with continuing reference to FIG. 1A, there is presented another view of electronic device 100 with components enabling electronic device 100 to function as a mobile communication device, within an expanded communication environment 101b. In addition to the functional and operational components already presented by and described within the description of FIG. 1A, FIG. 1B further illustrates expanded communications subsystem 130 with additional communication components and interfaces enabling electronic device 100 to perform wireless communications within an expanded communication environment 101b that includes other devices.

Communications subsystem 130 includes global positioning system (GPS) module 131 that enables electronic device to communicate with and receive GPS location data from GPS satellite(s) 195. In accordance with one or more embodiments, GPS module 131 receives geospatial input from GPS broadcasts of time data and location data from GPS satellite(s) 195 to obtain geospatial location information about the physical location of electronic device 100.

In accordance with one or more embodiments, controller 110, via communications subsystem 130, performs multiple types of cellular over-the-air (OTA) or non-cellular wireless communication, such as by using a Bluetooth connection or other personal access network (PAN) connection. As shown, communications subsystem includes cellular communication system 132, which includes at least one radio frequency RF front end coupled to one or more antennas. In accordance with one or more embodiments, cellular communication system 132 can include a communication module with one or more baseband processors or digital signal processors, one or more modems, and a radio frequency (RF) front end having one or more transmitters and one or more receivers. In accordance with one or more embodiments, controller 110, via communications subsystem 130, may communicate via an OTA cellular connection with radio access networks (RANs) over a cellular wireless communication network (CWCN) 175. CWCN 175 can be a terrestrial network and include a plurality of base stations and associated network server(s) 176, in one embodiment. Cellular communication system 132 allows electronic device 100 to communicate wirelessly with CWCN 175 via transmissions of communication signals (represented as lightning bolts) to and from network communication devices, such as base stations or cellular nodes, of CWCN 175. Alternatively, or in addition, CWCN 175 can include a satellite network, and electronic device 100 connects to CWCN 175 using satellite communication system 133. Cellular communication system 132 and satellite communication system 133 enable electronic device 100 to engage in long distance wireless communication capabilities.

In accordance with one or more embodiments, communications subsystem 130 includes integrated short range wireless interface chipset 134 having one or more of Wi-Fi transceiver (TxRX) 135, Bluetooth (BT) TxRx 136, near field communication (NFC) transceiver 137, and ultra-wideband (UWB) transceiver 138. In accordance with one or more embodiments, the short-range communication devices are not integrated on a single chipset but can be separately provided hardware components. In accordance with one or more embodiments, electronic device 100 can communicate wirelessly with external wireless devices, such as a Wi-Fi router of a wireless local area network (WLAN) 178 and/or second electronic device 104, via one or more short-range wireless interface(s). In accordance with one or more embodiments, electronic device 100 can receive Internet or Wi-Fi based calls, text messages, multimedia messages, and other notifications via a combination of wireless and wired networks (generally networks 182).

In accordance with one or more embodiments, networks 182 can include CWCN 175, WLAN 178, and Wide Area Network (WAN) 180, such as the Internet. In accordance with one or more embodiments, WAN 180 can enable electronic device 100 to access application servers 190, which can provide a downloadable version of ASOA module 125 and/or access to other applications, online transactions, and resources. In accordance with one or more embodiments, networks 182 can also include personal area networks (PAN) 184, which are individually created with other second electronic devices (other than second electronic device 104) via one of short-range wireless devices from among Wi-Fi TxRX 135, BT TxRx 136, NFC transceiver 137, and UWB transceiver 138. Example of other second electronic devices include external display 165, wireless headset 166, and wearable computing device 192. External display 165 can be a stand-alone monitor/display or a display integrated into a second electronic device, such as a laptop computer. In at least one embodiment, connection to the external display 165 can be wired and can include an intermediate connection device, such as a docking station device.

Electronic device 100 also includes a physical interface 106. Physical interface 106 of electronic device 100 can serve as an input/output data port and can be used as a power supply port that is coupled to charging circuitry 168 which feeds electrical power to device battery 169 to enable recharging of device battery 169 and/or powering of electronic device 100. As a data port, physical interface 106 can enable electronic device 100 to be physically coupled via a cable or docking station port to a second device, such as external display 165.

FIG. 1B also presents additional details of image capturing device(s) (ICD(s)) 152 of electronic device 100. Throughout the disclosure, the term image capturing device (ICD) is synonymous with and/or utilized interchangeably with any one of the cameras of electronic device 100. ICD(s) (or cameras) 152 includes front cameras 152a and rear cameras 152b. In one embodiment, each of front cameras 152a and rear cameras 152b are communicatively coupled to ICD controller 116. ICD controller 116 supports the processing of image data from front cameras 152a and rear cameras 152b. Front cameras 152a can include a main camera and a wide-angle camera. Rear cameras 152b can include a main camera, a wide-angle camera, and a telephoto camera. Both sets of cameras 152 include image sensors that can capture images that are within the field of view (FOV) of each respective camera 152. In accordance with one or more embodiments, one or more of the cameras can be utilized to enable biometric authentication using facial image or iris scan recognition.

With reference to FIGS. 1A-1B, according to aspects of the present disclosure, electronic device 100 includes at least one input device 151 and at least one output device 160. Electronic device 100 has memory 120 including ASOA module 125 that may configure electronic device 100 to perform operations to detect user engagment with an OIS UI and to determine whether the content of the OIS UI has characteristics that may be determined to be associated with the potentially misleading or confusing information. Alternatively, or in addition, ASOA module 125 may configure electronic device 100 to modify the OIS UI to enable the user 102 to be more informed of the content of the OIS UI, thus reducing the risk of the user 102 selecting an unclear call to action that could lead to unintended or inadvertent installation or acceptance of applications and/or services/agreements based on potentially misleading or confusing information in the original OIS UI.

Electronic device 100 includes communications subsystem 130 that links electronic device 100 to communication network 201 for the one-way or two-way communication session. Processor 112 of electronic device 100 is communicatively coupled to memory 120, communications subsystem 130, at least one input device 151, and at least one output device 160. In accordance with one or more embodiments, electronic device 100 includes microphone 153 that is communicatively coupled to processor 112.

In the description of each of the following figures, reference is also made to specific components illustrated within the preceding figure(s). Similar or same components are presented with the same leading reference number.

FIG. 2 illustrates hardware and software components of electronic device 100 that enables detecting and correcting/modifying potentially misleading or confusing information(s) associated with an OIS UI, in accordance with one or more embodiments. Electronic device 100 includes memory 120 and artificial intelligence (AI) engine 115. In one or more embodiments, the memory 120 includes policy compliance requirements 250, user preferences 252, and peer user input 254. The policy compliance requirements 250 include information related to applicable policies (e.g., privacy rights 251) that the OSI UI or the information included in the OSI UI need to comply with. The user preferences 252 include information that is based on inputs originating from or associated with the user 102. The peer user inputs 254 include input or feedback provided by other users via crowd-sourcing. The peer users input 254 may be collected and stored in the cloud for download to the electronic device 100.

In one or more embodiments, the AI engine 115 is trained to identify information related to the potentially misleading or confusing information included in the content of the OIS UI with which the user 102 is interacting. In an example, AI engine 115 is or includes one or more of AI OS 117 and AI model 126. In one or more embodiments, the AI engine 115 is trained at least in part based on the policy compliance requirements 250. In one or more embodiments, the AI engine 115 is trained at least in part based on the user preferences 252. In one or more embodiments, the AI engine 115 is trained at least in part based on peer user inputs 254.

In one or more particular embodiments, AI engine 115 is further trained to predict/suggest/provide/recommend an alternative content instead of or in addition to the original content of the OIS UI. In one example, the alternative content may be a more concise version of the original content presented within a window that overlaps the displaying of the original content. In one or more particular embodiments, AI engine 115 is further trained to predict/suggest/provide/recommend one or more selectable options in addition to or instead of the original automatic selection options(s). In one or more particular embodiments, AI engine 115 is further trained to predict/suggest/provide/recommend modifying the original OSI UI to remove misleading or confusing information. The modification of the original OSI UI can include unselecting previous pre-selected options.

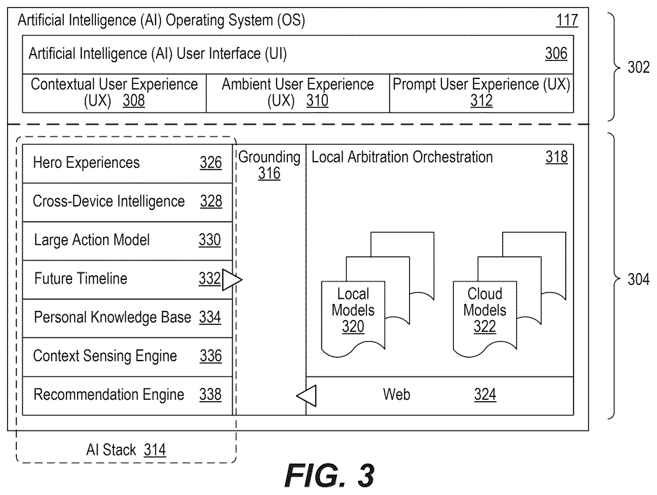

FIG. 3 illustrates a software platform diagram of an example artificial intelligence (AI) operating system (OS) 117. By learning about the user, AI OS 117 can analyze content of and the automatic selection of an OIS UI to determine if the content and the automatic selection is consistent with at least the user preferences 252. The AI OS 117 can further determine, based at least on the user preferences 252, highlight one or more portions of the content to inform the user of the potentially misleading or confusing information included in the content. In the alternative, or in addition, the AI OS 117 can also generate alternative or modified content to inform the user of the intent of the original content of the OIS UI. In accordance with one or more embodiments, the AI OS 117 can further use historical actions responsive to the requests for actions to predict/suggest/provide/recommend additional selectable options responsive to the requests for actions. In accordance with one or more embodiments, the AI OS 117 can further use knowledge of historical misleading or confusing information included in the requests for actions within original OIS UIs (the historical misleading or confusing information deduced from analysis of the AI models) and relevant policy compliance requirements 250 (established user, device, and/or application policy) to predict/suggest/provide/recommend the alternative or modified content, alternative or modified requests for actions, and/or additional selectable options. In accordance with one or more embodiments, the AI OS 117 can further use relevant policy compliance requirements 250 (e.g., established user, device, and/or application policy) to /edict/suggest/ provide/recommend the alternative or modified content, alternative or modified requests for actions, and/or additional selectable options. In accordance with one or more embodiments, the AI OS 117 can use both knowledge of historical deceptive behavior included in the requests for actions within original OIS UIs and any relevant policy compliance requirements 250 to determine how to modify the OIS UI.

The AI OS 117 supports functionality of ASOA module 125 (FIG. 1B) that monitors and detects user engagement with the electronic device 100, analyze information related to the OIS UI that the user 102 engages with to determine whether the OIS UI presents pre-selected options and CTAs in a format that could cause the user to inadvertently opt-in to the pre-selected option and predict/suggest/provide/recommend solutions to reduce the likelihood of the user making/selecting that inadvertent/undesired opt-in. AI OS 117 includes user plane 302 supported by control plane 304. User plane includes AI user interface (UI) 306 that supports contextual user experience (UX) component 308, ambient UX component 310, and prompt UX component 312. Control plane 304 includes AI agents 314 that communicate via grounding component 316 to local arbitration orchestration component 318 having local models 320 and cloud models 322. AI agents 314 communicates via grounding component 316 to web interface 324. AI agents 314 includes hero experiences agent 326, cross-device intelligence agent 328, large action model 330, future timeline 332, personal knowledge base 334, context sensing engine 336, and recommendation engine 338.

Grounding component 316 in AI is an essential process that ensures AI systems comprehend and interact with the real world accurately. Grounding is a bridge between abstract AI concepts and practical, tangible outcomes. Grounding allows AI systems to bridge semantic gaps in the real world, team with other agents in such environments, process inputs from the environment, and learn from interactions. A successful synthetic teammate requires several cognitive capacities, including situation assessment, task behavior, language comprehension and generation, and knowledge gap resolution processes. Grounding enables agents with different capabilities to communicate.

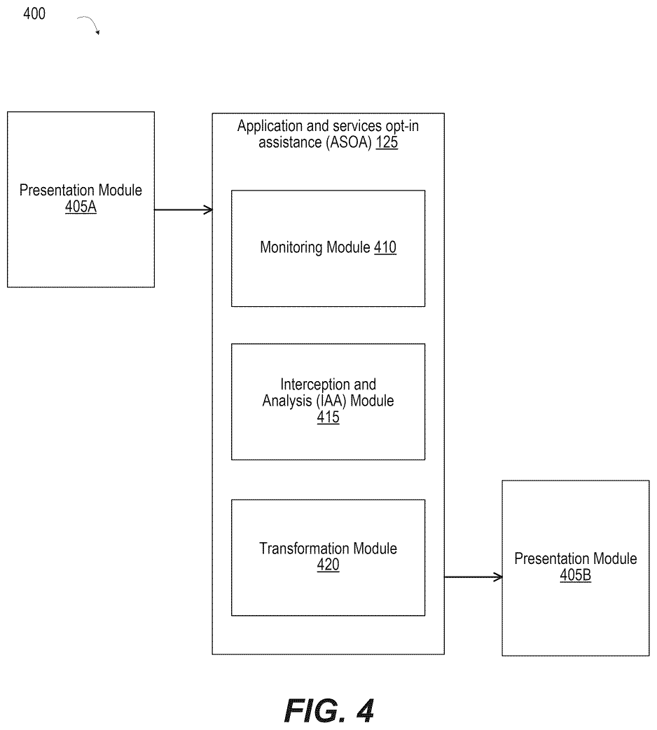

FIG. 4 presents a block diagram illustration of an application and services opt-in assistance (ASOA) module for facilitating user understanding of and interfacing with an opt-in selection UI, in accordance with one or more embodiments. The functionality of ASOA module 125 may include/comprise the individual functionality of the monitoring module 410, the interception and analysis module 415, and the transformation module 420.

In accordance with one or more embodiments, the functionality of the ASOA module 125 may further encompass the functionality of the presentation module 405A, which can be configured to present information related to an application having OIS UI to the monitoring module 410. The monitoring module 410 can configure processor 112 to cause electronic device 100 to capture and analyze the content of the OIS UI, including the information to be displayed on the screen of the display 161 of the electronic device 100. The monitoring module 410 further includes program instructions that configure processor 112 to cause electronic device 100 to detect whether the OIS UI includes any automatic selection of options. The automatic selection can be presented with request for action(s) (or call to actions) such that, for example, in response to the user 102 activating or clicking on a button associated with the request for action, the action of the user 102 can be interpreted as the user agreeing to opt-in or granting permission for the application or device to proceed to a next phase of its operation and accept the selections as if made or confirmed by the user. For example, the OIS UI may be associated with an application, and the next phase may include the application presenting another OIS UI or continuing to other operations.

In accordance with one or more embodiments, the automatic selection can be in the form of pre-selected option(s). The automatic selection can also include misleading or confusing information presented in the form of text string(s) such as, for example, a description of what is being presented to the user within the OIS UI or an instruction telling the user 102 what the user 102 needs to do next. In an example, the pre-selected options can include pre-selected radio buttons or checkboxes associated with the options. In another example, the text strings can be presented within a window in the OIS UI encouraging the user 102 to follow the included instructions.

The monitoring module 410 can use services such as device level accessibility service, screen parsing and optical character recognition (OCR) service, pattern recognition service, and permission monitoring service to analyze the content of the OIS UI. In an example, the device level accessibility service can use features that are built directly into the electronic device 100 (e.g., a smart phone) to assist a user to easily interact with the electronic device 100. One example of such feature is screen reading which reads the text presented on a screen of the display 161, thus allowing the user 102 to access information and perform actions when the user has difficulty seeing, hearing, or manipulating the screen of the electronic device 100. In another example, the screen parsing and OCR service can include service that analyzes and extracts text from a screen content to identify and interpret any automatic selection such as opt-in dialogs. In another example, the pattern recognition service can include a feature that detects common misleading or confusing patterns used in OIS UIs. The common patterns used to provide misleading or confusing information can include using pre-checked boxes and/or hiding decline options.

The interception and analysis (IA) module 415 can include program instructions that cause or configure processor 112 to cause electronic device 100 to process the content of the OIS UI captured by the monitoring layer 410. The IA module 415 can include program instructions that cause or configure processor 112 to cause electronic device 100 to use contextual and risk analysis to identify the potentially misleading or confusing information. The contextual analysis can include natural language processing (NLP) analysis and semantic analysis. For example, the IAA module 415 can use language models to understand the content and the context of the opt-in requests to identify potential misleading or deceptive language. According to one or more embodiments, the risk analysis can include risk scoring by assigning a risk score to each opt-in based on its potential impact on privacy, security and user experience. As an example, the risk score can be categorized as a low-risk score, a medium-risk score, and a high-risk score. With a low-risk score, there may be no need to modify the OIS UI. With a medium-risk score, the OIS UI can be modified by overlaying the content of the OIS UI with helpful information such as tool tips, opt-out assistance, hints, etc. With a high-risk score, in addition to the actions described with the medium-risk score, the IAA module 415 can transform the OIS UI further by taking various actions such as, modifying the CTAs, unhiding any collapsed sections, and unselecting any pre-selections, etc.

In an alternative, or in addition, the IAA module 415 can include program instructions that cause or configure processor 112 to cause electronic device 100 to compare the result of the context analysis and compare that with available privacy policies related to the OIS UI to detect any automatic selection or opt-in options associated with the privacy policies. In an alternative, or in addition, the IAA module 415 can be configured to use the AI engine 115, which is trained to learn from one or more of historical actions responsive to the requests for actions, historical misleading or confusing information included in the requests for actions, aggregated information from other sources, feedback/insights from peer user inputs 254, user insights/preferences 252 and inferences based on past interactions with the particular applications or categories of applications to improve the accuracy and relevance of the contextual analysis. The AI engine 115 can also be used to improve the accuracy of determining the potentially misleading or confusing information associated with the OIS UI of certain particular applications.

The transformation module 420 can include program instructions that cause or configure processor 112 to cause electronic device 100 to transform or modify the OIS UI by including content that provides clearer guidance, explanations, and assistance to the user 102 to ensure informed decision making by the user 102 regarding the automatic selection and the request for action(s) included in the OIS UI. In accordance with one or more embodiments, the transformation module 420 can include program instructions that cause or configure processor 112 to cause electronic device 100 to transform or modify the OIS UI by providing clearer information than the information included in the original OIS UI and presenting the clearer information within an overlay window. In accordance with one or more embodiments, the transformation module 420 can modify or transform the original OIS UI by modifying the request for action(s) and/or generating and presenting new request for action(s) that clarifies available options and reduces the likelihood of accidentally or unintentionally accepting the automatic selection. In accordance with one or more embodiments, the transformation module 420 can modify or transform the OIS UI by providing hints and/or explanations to the user 102 to help the user get a better understanding of the implications of their selections.

The transformation module 420 can include program instructions that cause or configure processor 112 to cause electronic device 100 to provide easy-to-follow instructions on how to decline consent, revoke consent, or opt out of unwanted services. In accordance with one or more embodiments, the transformation module 420 can include program instructions that cause or configure processor 112 to cause electronic device 100 to modify or transform the OIS UI by deselecting pre-selected option(s), notifying the user 102 of the existence of hidden or not-readily-visible information, and providing tips to explain to the user 102 how to select and/or deselect the available options and how to view or access the hidden information. The presentation module 405B can include program instructions that cause or configure processor 112 to cause electronic device 100 to present the results of the transformation module 420 to the user 102, including presenting the modified OIS UI on the screen within the display 161 of the electronic device 100. The modified OIS UI is presented in place of the original OIS UI and operates as the UI for the specific feature of the device or the application that the user is interacting with.

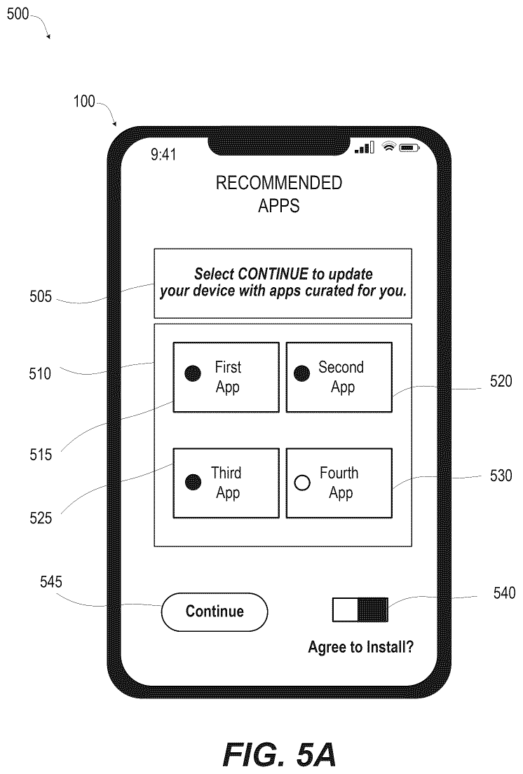

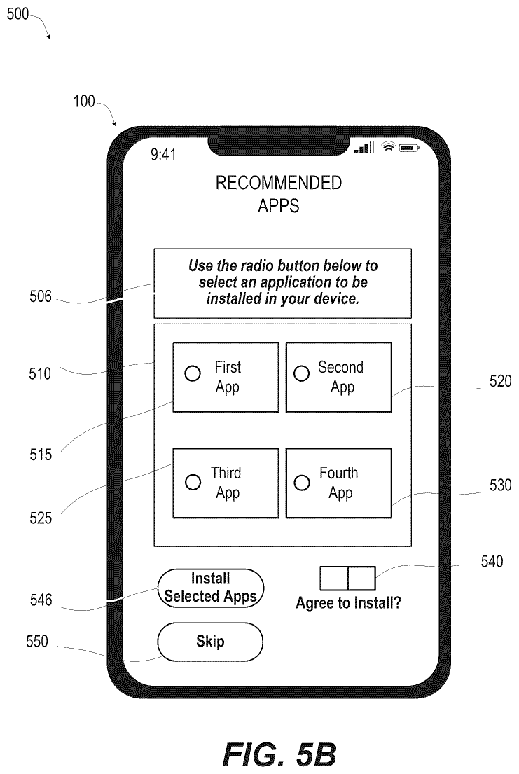

FIGS. 5A-5B provide a sequence of opt-in selection UIs illustrating operation of the ASOA module to modify an OIS UI by adding additional descriptive content and selectable skip option to facilitate user interfacing without inadvertent opt-in of pre-selected options, in accordance with one or more embodiments. The example OIS UI of FIG. 5A is related to installation of recommended applications. The example OIS UI includes content having description window 505 and options window 510. The OIS UI also includes a request for action 545 (“Continue” button) and an on/off installation setting bar 540. The description window 505 includes a description that encourages the user 102 to agree with the request for action 545 by selecting or clicking on the “Continue” button. The options window 510 illustrates four selectable options corresponding to four curated applications that can be installed on the electronic device 100. To select an application to be installed, the user 102 can click on the radio button presented next to the description identifying the application. In the current example, each of the radio buttons associated with the first application 515, the second application 520, and the third application 525 has been pre-selected, while the radio button associated with the fourth application 530 is unselected. While automatically pre-selected within original OIS UI, the example assumes that pre-selected applications 515, 520, 525 include one or more applications the user does not want to install on the device.

Original OIS UI 500 includes notification 505 that includes somewhat deceptive content 507 (i.e., “apps curated for you”) presented as information to motivate a user to proceed with selecting the request for action 545), which would lead the user to believe that the installation is limited only to the presented pre-selected applications 515, 520, 525. The example OIS UI of FIG. 5A illustrates several types of possible deception that may cause an uninformed user to be confused about actions that can be taken. As one possible intent to mislead or confuse the user 102, the options window 510 illustrates to the user 102 that there are only three pre-selected applications 515, 520, and 525, but the description in the description window 505 is vague because it does not specifically mention that the installation is limited to the three pre-selected applications 515, 520, and 525. The vague description can mislead the user 102 into agreeing with the installation of all four applications 515, 520, 525 and 530. As another possible intent to mislead or confuse the user 102, the on/off installation setting bar 540 is pre-set to an “on” state instead of an “off” state, thus encouraging the user 102 to agree to the “on” state and grant permission to proceed with the installation of all four applications 515-530, without the user 102 having to interact with the on/off installation setting bar 540.

As another possible intent to mislead or confuse the user 102 into making the selection of the applications to install on the user device, the example OIS UI of FIG. 5A offers no information to explain to the user 102 how to select or de-select the radio buttons corresponding to the applications 515, 520 and 525 and how to modify the on/off installation setting bar 540. Accordingly, an uninformed user is made to believe that the pre-selected radio buttons and the pre-set on/off setting cannot be de-selected or changed, even though the user 102 has no desire to install the applications 515, 520 and 525 in the electronic device 100. Additionally, the request for action 545 is associated with a “Continue” button, which is vague and can lead an uninformed user to believe that by selecting or clicking on the “Continue” button, more information will be presented before installation of any of the applications identified in the options window 510 is triggered. To proceed to a next screen without installing the pre-selected applications, the user has to either deselect the pre-selected applications 515, 520, 525 or toggle off the “agree to install” bar 540 before selecting the “Continue” button as the response to the request for action 545.

Referring to FIG. 5B, an example modified OIS UI corresponding to the example original OIS UI of FIG. 5A is presented. The example modified OIS UI includes modified content and alternative requests for action to help inform the user of the ability of the user to select or skip selecting one or more of the available options in options window 510 before proceeding. The content of the example modified OIS UI of FIG. 5B includes description window 506 and options window 510. Instead of using the description included in the description window 505, the description included in the description window 506 is modified and clearly instructs the user 102 to use the radio button to select/deselect an application to be installed/ignored. Further, the radio buttons associated with each of the applications identified in the option window 510 is presented to the user 102 as unselected, thus providing the user 102 the opportunity to select each individual application to be installed.

The example modified OIS UI of FIG. 5B also includes two different requests for actions 546 and 550, instead of the single request for action 545 of FIG. 5A. The request for action 546 clearly conveys that when the user 102 selects or clicks on the “install selected apps” button, the apps selected in the options window 510 will be installed. To assist the user 102 to bypass installing any of the applications identified in the options window 510, the request for action 550 is presented to convey that when the user 102 selects or clicks on the “Skip” button, no installation will be performed. The example modified OIS UI of FIG. 5B also includes the on/off installation setting bar 540 with no pre-set (i.e., toggled off, to the no side), thus providing the user the opportunity to set it to the “on” state or “off” state when desired by the user.

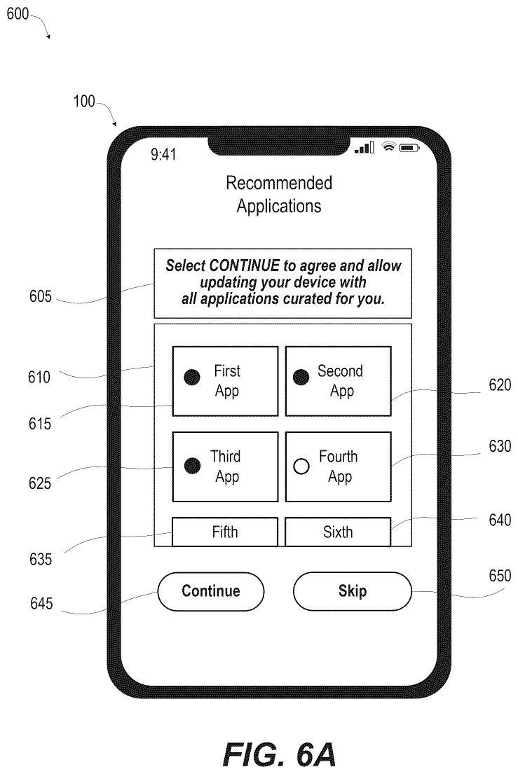

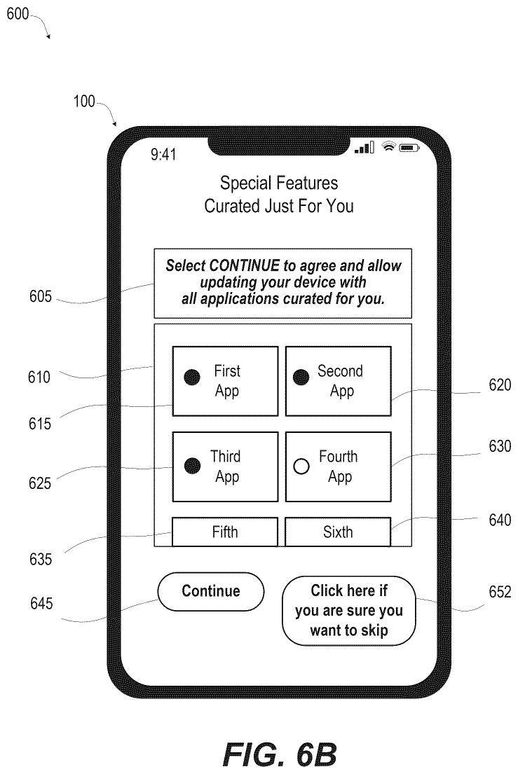

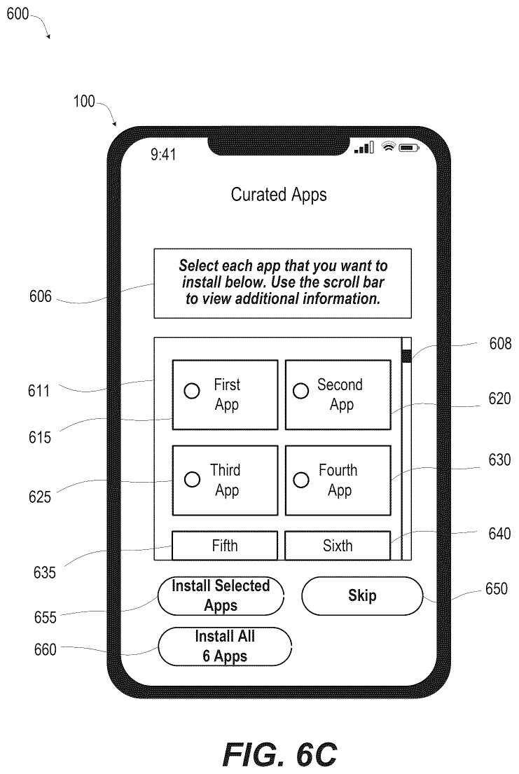

FIGS. 6A-6C presents a sequence of opt-in selection UIs illustrating modification and/or replacement of an initial opt-in selection UI having hidden content and a vague request for action with a modified opt-in selection UI that presents a clearer request for action and access to view the hidden content, in accordance with one or more embodiments. The example OIS UI presented in FIG. 6A refers to installation of recommended applications. The example OIS UI includes content having description window 605 and options window 610. The OIS UI also includes two requests for action 645 (“Continue” button) and 650 (“Skip” button”). The description window 605 includes a description that encourages the user 102 to proceed with the request for action 645 by selecting or clicking on the “Continue” button. The options window 610 illustrates six selectable options corresponding to six applications 615-640 that can be installed in the electronic device 100. To select an application to be installed, the user 102 can click on the radio button presented next to the description identifying the application. In the example OIS UI presented in FIG. 6A, only information identifying the four applications 615-630 is visible to the user 102, while the information identifying the remaining two applications 635-640 is not fully visible to the user 102.

As one example of potentially misleading or confusing information, even though the options window 610 illustrates to the user 102 that there are only three pre-selected applications 610, 615, and 620, the description in the description window 605 is potentially misleading or confusing because it mentions that the installation is applicable to all applications curated for the user 102. The description is potentially misleading or confusing because it's not clear whether the phrase “all applications” refer to all selected/pre-selected applications or all applications having information presented in the options window 610 regardless of whether they are selected/pre-selected or non-selected. Also, it is unknown to the user 102 whether the fifth application 635 and the sixth application 640 are pre-selected or non-selected unless the user 102 becomes aware that he needs to scroll down the presented options window 610 to cause the information related to the fifth application 635 and the sixth application 640 to be visible. The OIS UI offers no guidance or instruction for the user 102 to scroll or to cause the information related to the fifth application 635 and the sixth application 640 to become visible.

As another example of potentially misleading or confusing information, it would be reasonable for the user 102 to anticipate that when the user 102 proceeds with the request for action 650 associated with the “Skip” button, the installation of all the applications described in the options window 610 would be skipped or bypassed. However, as presented in the example second OIS UI of FIG. 6B, instead of by-passing the installation of the applications, another request for action 652 (“are you sure”) is presented requiring the user 102 to think twice about the decision to skip the installation. In accordance with one or more embodiments, the application associated with the OIS UI of FIG. 6A can be modified to disable or remove the second request for action 652 such that the second OIS UI of FIG. 6B is not presented to the user 102.

Referring to FIG. 6C, an example modified OIS UI corresponding to the original OIS UI of FIG. 6A is presented. The content of the modified OIS UI of FIG. 6C includes description window 606 and options window 611. A scroll bar 608 is presented with the options window 611. Instead of using the original description included in the description window 605, the modified description included in the description window 606 clearly instructs the user 102 to select applications to be installed. Further, the radio button associated with each of the applications identified in the options window 611 is presented to the user 102 as unselected, thus providing the user 102 the opportunity to select each individual application to be installed. The description in the description window 606 further instructs the user 102 to use the scroll bar 608 to view information that is not currently visible in the options window 610.

The example modified OIS UI of FIG. 6C also includes two different requests for actions 655 and 660, instead of the original request for action 645 presented in FIG. 6A. The request for action 655 clearly conveys that when the user 102 selects or clicks on the “install selected apps” button, the apps selected in the options window 611 will be installed. To assist the user 102 to install all of the applications identified in the options window 610, the second request for action 660 can be presented to inform the user 102 of the total number of applications that will be installed if the user 102 decides to proceed with the second request for action 660.

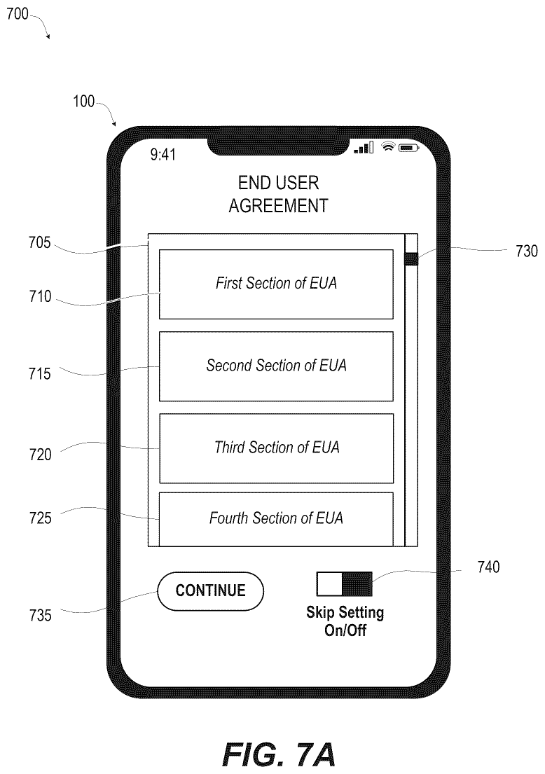

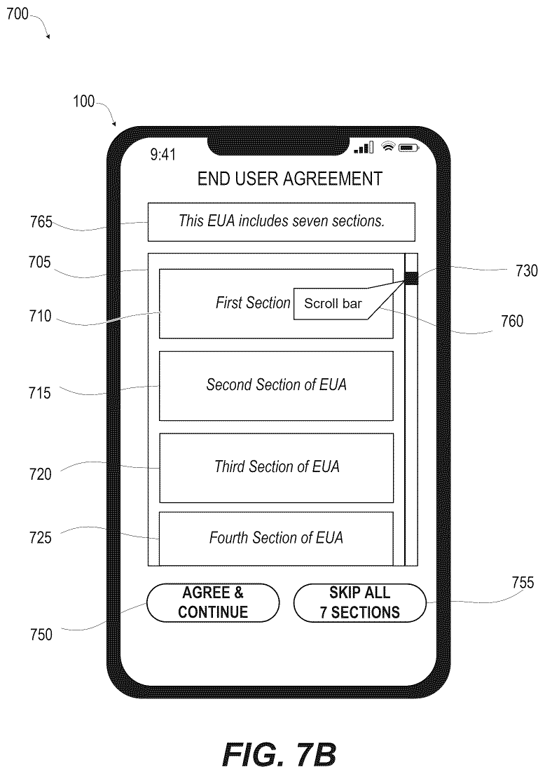

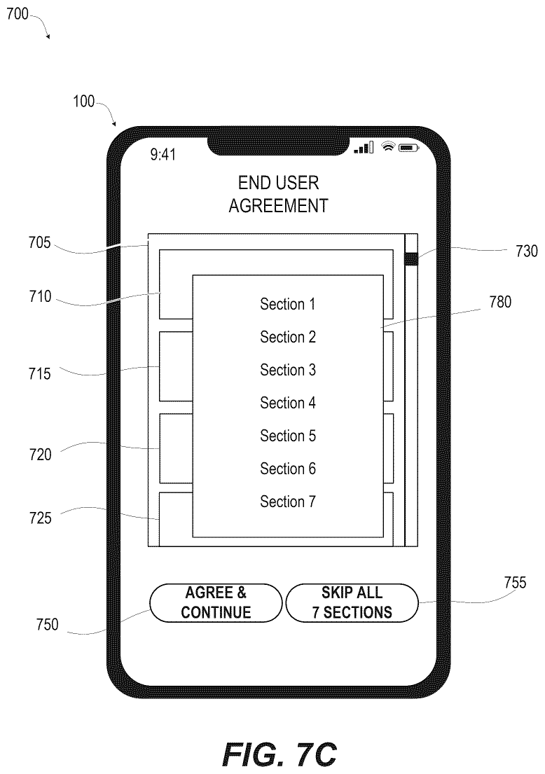

FIGS. 7A-7C presents another sequence of opt-in selection UIs illustrating modification and/or replacement of an initial opt-in selection UI that includes multiple pages of content including some hidden pages with an example modified opt-in selection UI presenting all of the pages via an overlay format, in accordance with one or more embodiments. The example OIS UI presented in FIG. 7A refers to displaying an end user agreement (EUA). The OIS UI includes content presented within the EUA window 705. The OIS UI also includes a request for action 735 (“Continue” button) and an on/off confirmation setting bar 740. The EUA window 705 presents a seven-section EUA, with only sections 710-725 being visible, while the remaining sections are hidden. The user 102 is required to use the scroll bar 730 to view the sections that are hidden. To bypass or skip reading all of the sections of the EUA, the user 102 can set the on/off confirmation setting bar 740 to an “on” state to provide confirmation that the user 102 agrees or grants permission for the EUA to proceed to a next page. The user 102 can then select or click the “Continue’ button associated with the request for action 735.

The example OIS UI presented in FIG. 7A includes potentially misleading or confusing information that may cause the user 102 to be confused of actions that can be taken. As one example of potentially misleading or confusing information, the on/off confirmation setting bar 740 is pre-set to an “on” state, thus encouraging the user 102 to grant the permission to proceed without having to interact with the on/off confirmation setting bar 740. Further, the potentially misleading or confusing information included in the OIS UI includes the vague “Continue” button associated with the request for action 735, causing the user 102 to believe that by selecting or clicking on the “Continue” button, the hidden sections of the EUA woud become visible. In addition, the potentially misleading or confusing information also includes failing to provide instruction to explain to an uninformed user to use the scroll bar 730 to view the hidden sections of the EUA.

Referring to FIG. 7B, an example modified OIS UI corresponding to the OIS UI of FIG. 7A is presented. The content of the example modified OIS UI of FIG. 7B includes description window 765, tool tip 760. The example modified OIS UI of FIG. 7B also includes two requests for action 750 and 755. The request for action 735 and the on/off setting 740 of the orignal OIS UI of FIG. 7A have been removed from the example modified OIS UI of FIG. 7B. The addition of the description window 765, the tool tip 760, and the two requests for action 750 and 755 assists the user 102 to be more informed about the actions that the user can take to interact with example modified OIS UI. For example, the description window 765 includes a description that informs the user 102 that the EUA includes muliple sections more than the sections that are currently visible. This can lead the user 102 to find out how to view the hidden sections. The tool tip 760 explains to the user 102 about using the scroll bar to view the hidden sections. The request for action 755 associated with the “Skip all 7 sections” button informs the user 102 that the skipping action actually skips viewing all seven sections of the EUA, not just the visible sections. The request for action 750 helps conveying to the user 102 that by selecting or clicking on the button “Agree and Continue”, the user agrees to the terms of the EUA and grants permission for the example modified OIS UI to proceed to a next phase.

Referring to FIG. 7C, an example modified OIS UI corresponding to the OIS UI of FIG. 7A is presented. The content of the example modified OIS UI of FIG. 7C includes overlay window 780. The example modified OIS UI of FIG. 7C also includes the two requests for action 750 and 755 of the example modified OIS UI of FIG. 7B. In accordance with one or more embodiments, as one example, ASOA module 125 may configure electronic device 100 to analyze content of an OIS UI associated with an application the user 102 is interacting with to determine whether the content of the rendered OIS UI includes multiple pages with at least one page not being visible to the user 102 without the user 102 taking additional action(s) (e.g., scrolling down or selecting a next/forward arrow). With this example, ASOA module 125 configures processor 112 to cause electronic device 100 to generate a modified OIS UI presenting a clear indication of the total number of pages and a selectable affordance for the user to easily access the hidden pages of content without accepting (or affirmatively responding to) the call to action. In the example modified OIS UI of FIG. 7C, the overlay window 780 includes a modified version of or individual links to all of the sections of the EUA such that relevant information of the EUA can be visible to the user 102. In one example, the modified version of the EUA can be a summary of the EUA. In another example, the modified version of the EUA can be the same EUA presented in smaller size to fit entirely within the overlay window 780.

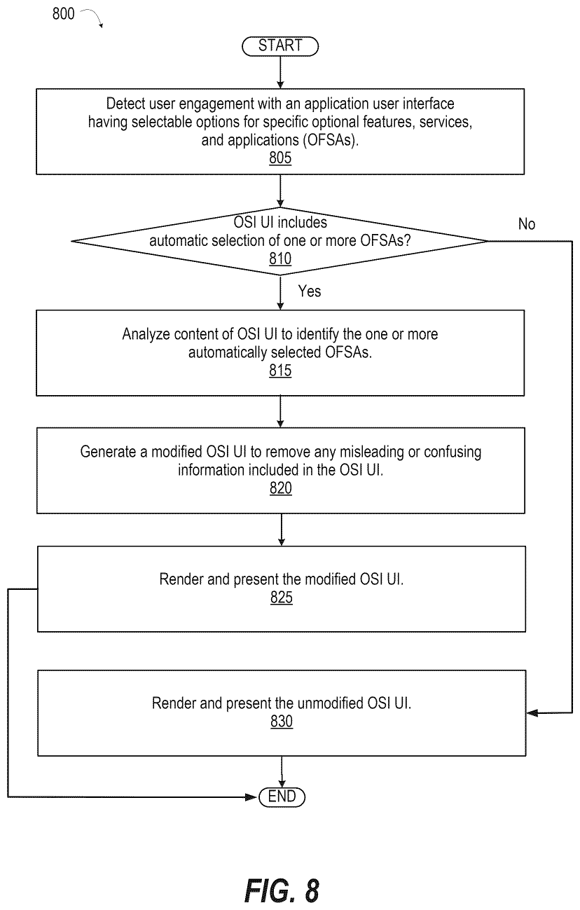

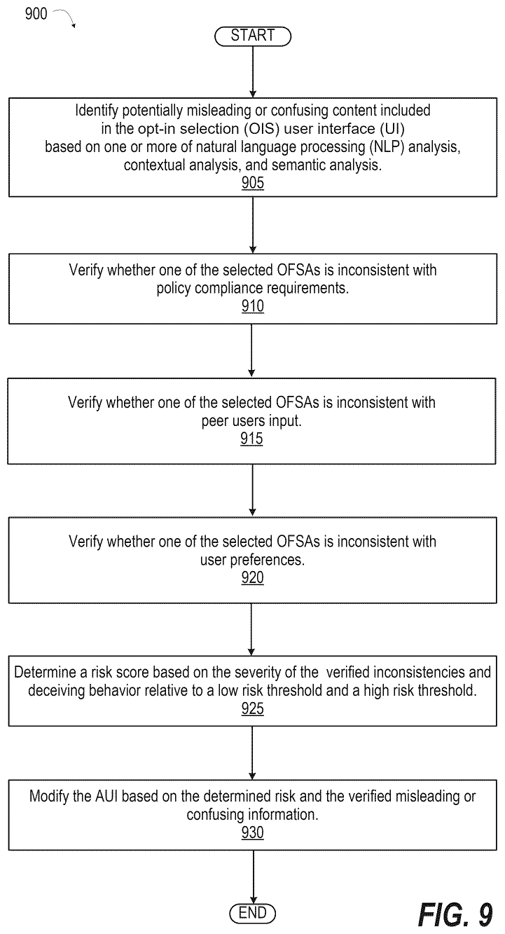

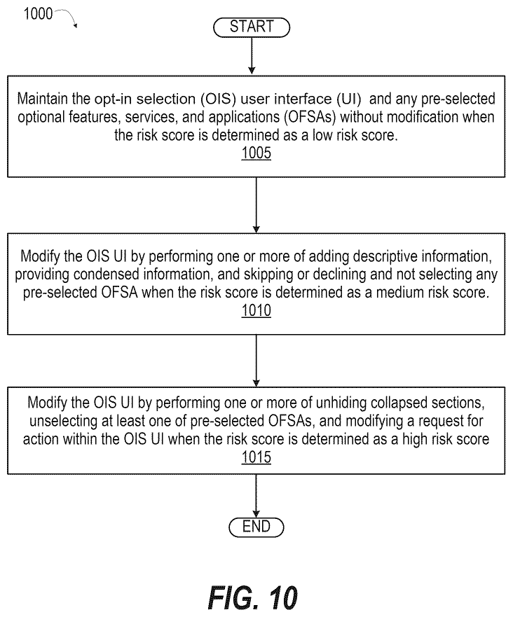

FIG. 8 is a flow diagram presenting a computer-implement method for generating and presenting a modified OIS UI to facilitate user engagement therewith and prevent inadvertent opt-in of pre-selected options due to restrictive and/or potentially misleading or confusing options in an original OIS UI, in accordance with one or more embodiments. FIG. 9 is a flow diagram presenting a computer-implement method for using a plurality of stored parameters to determine risk associated with potentially misleading or confusing information included in the presented OIS UI, in accordance with one or more embodiments. FIG. 10 is a flow diagram presenting a computer-implement method for modifying an OIS UI based on a determined risk level, in accordance with one or more embodiments. The descriptions of method 800 (FIG. 8), method 900 (FIG. 9), and method 1000 (FIG. 10) are provided with general reference to the specific components illustrated within the preceding FIGS. 1-7. Specific components referenced in method 800 (FIG. 8), method 900 (FIG. 9) and method 1000 (FIG. 10) may be identical or similar to components of the same name used in describing preceding FIGS. 1-7. In accordance with one or more embodiments, controller 110 (FIG. 1A) configures electronic device 100 (FIGS. 1A-1B) or a similar computing device to provide the described functionality of method 800 (FIG. 8), method 900 (FIG. 9) and method 1000 (FIG. 10).

With reference to FIG. 8, method 800 includes the procesor(s) 112 detecting the processor opening an OIS UI to present on the display 161 of the electronic device 100 (block 805). The OIS UI includes content and at least one request for action. The content includes selectable options for specific optional features, services, and applications (OFSAs). The selectable options can be presented with an input, such as, for example, a radio button or a checkbox to indicate when a selection is made. Method 800 includes determining whether any of the selectable options of the OFSAs has been pre-selected (or automatically selected) (decision block 810). For example, the operations performed in block 810 may include pre-rendering of the UI and identifying the items that are preselected from the pre-rendered images or performing code analysis on the executable OS or application code for code functions/features that are indicated as selections within an original OIS UI.

Method 800 includes, in response to not detecting any automatic selection, continuing to render and present the OIS UI with no modification (block 830). Alternatively, in response to detecting the automatic selections of one or more OFSAs, the content of the OIS UI is analyzed to identify the pre-selected options or automatic selections of the one or more OFSAs (block 815). The analysis of the content of the OIS UI can be performed using an artificial intelligence (AI) engine 115 (FIG. 2) trained to predict potential misleading or confusing information included in the content and in any of the request for action(s). Some examples of the potential misleading and confusing information are illustrated in FIG. 5A, FIG. 6A, and FIG. 7A. In accordance with one or more embodiments, the AI engine 115 is trained at least in part based on the user's personal feedback and/or pre-established preferences 252. For example, based on past interactions with other OIS UI, the user 102 may indicate a preference to review all end user agreements in their entireties without skipping. In an example, AI engine 115 is or includes one or more of AI OS 117 and AI model 126.

Method 800 includes generating a modified OIS UI to help the user 102 avoid the potentially misleading or confusing information identified by the AI engine 115. The process for generating the modified OIS UI can include one or more of removing or modifying the request for actions, introducing additional and/or clearer instructions, removing confusing or deceptive description, and de-selecting the presented options. The modified OIS UI, can then be rendered and presented to the user 102 on a display of the electronic device 100, instead of the original OIS UI (block 825). It is appreciated that the modification occurs as a background process prior to the presentation of the original OIS UI on the display such that only the modified OIS UI is presented to the user for interacting therewith.

With reference to FIG. 9, method 900 includes more details of the analysis operations performed in block 815 of method 800. Method 900 utilizes different techniques to analyze the content of the OIS UI to identify the potentially misleading or confusing information. In accordance with one or more embodiments, method 900 includes analyzing content presented within original OIS UI to identify potentially misleading or confusing information with the selection of OFSAs, based on one or more of natural language processing (NLP) analysis, contextual analysis, and semantic analysis (block 905). For example, in response to detecting that the OIS UI includes a mixture of pre-selected option(s) and non-selected option(s) associated with installation of applications (e.g., the options illustrated in the options window 610 of FIG. 6A), and the description of the OIS UI (e.g., the description illustrated in the description window 605) refers to selecting the “Continue” button to install all of the applications, the OIS UI can be identified as including potentially misleading or confusing information.

In accordance with one or more embodiments, method 900 includes verifying whether any of the automatic selection of the selected OFSAs is inconsistent with policy compliance requirements 250 (block 910). In one example, there can be a policy compliance requirement related to privacy rights 251, and the policy requires that whenever an OIS UI presents privacy rights 251 to the user 102, it is prohibited to present a pre-selected option indicating that the user 102 is agreeing to skip reviewing the information about the privacy rights 251. In response to detecting a potential violation of a certain policy, the presesention of the OIS UI in the original form may need to be re-evaluated to determine whether the OIS UI needs to be modified.

In accordance with one or more embodiments, method 900 includes verifying whether one of the selected OFSAs is inconsistent with peer user inputs 254 (block 915). For example, the content of the OIS UI may include a pre-selected option agreeing to allow the application to access all financial data stored in the electronic device 100. This agreement is inconsistent with peer users input 254, which indicates that other users would decline to select such option. The peer users input 254 may include input previously provided by other users via crowd sourcing when presented with similar OIS UI. The peer users input 254 may be collected and stored in the cloud for download and analysis related to identifying the potentially misleading and confusing information included in the OIS UI. In accordance with one or more embodiments, method 900 includes verifying whether one of the selected OFSAs and the request for actions are consistent with the user preferences 252 (block 920). Using the same financial data example above, when the user preferences 252 indicate that the user 102 does not like to expose financial information stored in the electronic device 100 to any applications, then a pre-selected option of the OSI UI to allow access to the financial data would be inconsistent with the user preferences 252.

Method 900 includes determining a risk of the potentially misleading or confusing information to the user 102 (block 925). Using a scale ranging from a low-risk threshold and a high-risk threshold, each verified potentially misleading or confusing information can be assigned one of a low risk, a medium risk, or a high risk. For example, automatically agreeing to allow access to the financial data stored in the electronic device 100 may be considered a high-risk, while agreeing to allow access to the gallery of images stored in the electronic device 100 may be considered a medium-risk, and agreeing to allow access to the location information limited to while using the application can be considered a low-risk. In accordance with one or more embodiments, method 900 includes modifying the OIS UI based on the determined risk level of the verified potentially misleading or confusing information (block 930). The modified OIS UI can then be presented to the user 102, instead of presenting the original unmodified OIS UI, to help the user 102 avoiding the potentially misleading or confusing information.

With reference to FIG. 10, method 1000 includes more detail information of the OIS UI modification operations performed in block 930 of method 900. Method 1000 includes determining a level of risk or a risk rating for the content presented in the original OIS UI (block 1005). In response to determining the risk level (or a risk score) to be a low risk, method 1000 includes presenting the OIS UI in its original form including any pre-selected OFSAs and any existing request for action (block 1005). For example, any risk score that is at or below the low-risk threshold can be considered a low risk. In response to determining the risk level to be a medium risk, method 1000 includes modifying the OIS UI and presenting a modified OIS UI with at least one change to the original presentation of content from the original OIS UI (block 1010). For example, any risk score that is at or below the high-risk threshold and higher than the low-risk threshold can be considered a medium risk. In accordance with one or more embodiments, operations that can be performed to modify the OSI UI based on a medium risk include one or more of adding descriptive information, providing condensed information, and adding options for skipping or declining and not selecting any pre-selected OFSAs.

In response to determining the risk level to be a high risk, method 1000 further includes modifying the OIS UI (block 1015). For example, any risk score that is above the high-risk threshold can be considered a high risk. In accordance with one or more embodiments, operations that can be performed to modify the OIS UI based on a high risk include one or more of unhiding collapsed sections, unselecting at least one of pre-selected OFSAs, adding new request for action, removing a request for action, and modifying a request for action.

In accordance with one or more embodiments, the electronic device 100 (FIG. 1A), method 800 (FIG. 8), method 900 (FIG. 9), method 1000 (FIG. 10), and computer program product, such as RSD 145 (FIG. 1A), provide techniques for detecting potentially misleading or confusing information that can be included in an OIS UI associated with an application executing in the electronic device 100. The techniques include detecting a request for action within the OIS UI that triggers automatic selection of the OFSAs. The techniques also include performing contextual analysis of the content of the OIS UI to identify automatic selection of options, determining request for action(s) included in the OIS UI, analyzing the content and the request for actions to determine whether the OIS UI includes any potentially misleading or confusing information, and generating a modified OIS UI to enable the user 102 to avoid making selections of unwanted services or applications, allowing inadvertent installations, or inadvertently entering into agreements or agreeing to terms not intended, based on the potentially misleading or confusing information included in the original and unmodified OIS UI.

In accordance with one or more embodiments, the electronic device 100 (FIG. 1A), method 800 (FIG. 8), method 900 (FIG. 9), method 1000 (FIG. 10), and computer program product, such as RSD 145 (FIG. 1A), provide techniques for avoiding inadvertent or uninformed selection of options presented in an OIS UI by detecting potentially misleading or confusing information and generating a modified OIS UI, for presenting, within the modified OIS UI, one or more of (i) a selectable option to skip or decline-all and not select any of the OFSAs, (ii) a condensed listing of which OFSAs are currently selected, and (iii) additional descriptive information that provides an explanation of OFSAs that are currently selected and an effect of selecting the request for action.

In accordance with one or more embodiments, the electronic device 100 (FIG. 1A), method 800 (FIG. 8), method 900 (FIG. 9), method 1000 (FIG. 10), and computer program product, such as RSD 145 (FIG. 1A), provide techniques presenting, within the modified OIS UI, one or more of (i) updated information overlaying originally presented information, (ii) previously hidden or collapsed sections of the OIS UI, and (iii) the at least one pre-selected OFSAs unselected.

In accordance with one or more embodiments, the electronic device 100 (FIG. 1A), method 800 (FIG. 8), method 900 (FIG. 9), method 1000 (FIG. 10), and computer program product, such as RSD 145 (FIG. 1A), provide techniques for determining whether one or more characteristic associated with the request for action or at least one of the selected OFSAs is inconsistent with at least one safeguard standard. The processor is further configured to, in response to determining that the one or more characteristic is inconsistent with the at least one safeguard standard, perform one or more modifications from a group comprising (i) visibly presenting an explanation of the OFSAs that are currently selected and an effect of selecting the request for action with the OFSAs selected, (ii) overlaying originally presented information with updated information, (iii) adding a selectable option to skip or decline-all and not select any of the pre-selected OFSAs, (iv) unhiding collapsed or hidden sections of the OIS UI, and (v) dynamically unselecting the at least one pre-selected OFSAs.

In accordance with one or more embodiments, the electronic device 100 (FIG. 1A), method 800 (FIG. 8), method 900 (FIG. 9), method 1000 (FIG. 10), and computer program product, such as RSD 145 (FIG. 1A), provide techniques for analyzing all content of the OIS UI including hidden content to identify whether any one of the OFSAs includes deceptive language by utilizing an AI engine to perform one or more actions from a group comprising (i) natural language processing (NLP) analysis, (ii) contextual analysis, and (iii) semantic analysis.

In accordance with one or more embodiments, the electronic device 100 (FIG. 1A), method 800 (FIG. 8), method 900 (FIG. 9), method 1000 (FIG. 10), and computer program product, such as RSD 145 (FIG. 1A), provide techniques for analyzing all content of the OIS UI including hidden content to identify whether any one of the OFSAs are selected by utilizing an AI engine to implementing one or more actions from a group comprising of (i) screen parsing and optical character recognition (OCR), (ii) pattern recognition, (iii) permission monitoring, and (iv) device level accessibility service.

In accordance with one or more embodiments, the electronic device 100 (FIG. 1A), method 800 (FIG. 8), method 900 (FIG. 9), method 1000 (FIG. 10), and computer program product, such as RSD 145 (FIG. 1A), provide techniques for analyzing all content of the OIS UI including hidden content to identify whether any one of the OFSAs are selected by utilizing an AI engine to implementing one or more actions from a group comprising of (i) screen parsing and optical character recognition (OCR), (ii) pattern recognition, (iii) permission monitoring, and (iv) device level accessibility service.

In accordance with one or more embodiments, the electronic device 100 (FIG. 1A), method 800 (FIG. 8), method 900 (FIG. 9), method 1000 (FIG. 10), and computer program product, such as RSD 145 (FIG. 1A), provide techniques for retrieving feedback data collected from other users based on experiences of the other users interacting with one or more of the OFSAs; and determine whether the one or more characteristic include factors that are known to be deceiving based on the feedback data collected from the other users.

In accordance with one or more embodiments, the electronic device 100 (FIG. 1A), method 800 (FIG. 8), method 900 (FIG. 9), method 1000 (FIG. 10), and computer program product, such as RSD 145 (FIG. 1A), provide techniques for: determining, using an artificial intelligence (AI) engine, whether the information presented by the one or more characteristics includes information that is inconsistent with the safeguard standard, the AI engine trained to use at least aggregated data and insights related to user preferences, historical actions responsive to requests for actions, historical misleading or confusing information included in the requests for actions, and relevant policy compliance requirements; determine, using the AI engine, whether the request for action or the at least one of the selected OFSAs is presented in a manner to mislead or confuse the user into accepting the request for action or the at least one of the selected OFSAs, the AI engine trained to use the at least aggregated data and insights related to user preferences, the historical actions responsive to requests for actions, the historical misleading or confusing information included in requests for actions, and the relevant policy compliance requirements; and, in response to the AI engine determining that there is indication of misleading or confusing information, the processor is configured to generate a trigger to cause the OIS UI to be modified to reveal or remove the misleading or confusing information or enable user bypass of the request for action.

By providing the user 102 (FIG. 1A) with a modified OIS UI where any potentially misleading or confusing information determined to be of medium risk or high risk have been removed or modified, electronic device 100 prevents the user 102 from being misled into unknowingly accepting pre-selected options that the user 102 may not be willing to accept. In particular, the electronic device 100 performs various techniques for detecting potentially misleading or confusing information in an OIS UI and for generating a modified OIS UI to help the user 102 to be more informed with the user's selection of the options in an OIS UI.

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the innovation. As used herein, the singular forms “a”, “an” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

What is claimed is:

1. An electronic device comprising:
at least one input device;
at least one output device, including a display;
a memory having stored thereon a device and application and services opt-in assistance (ASOA) module;
a processor communicatively coupled to the at least one input device, the at least one output device, and the memory, and which is configured to cause the electronic device to:
detect user engagement with one or more opt-in selection (OIS) user interfaces (UI) presenting at least one selectable choice for opting in to specific optional features, services, and/or applications (OFSAs);
in response to detecting a request for action within the OIS UI that triggers automatic selection of at least one of the specific OFSAs:
analyze all content of the OIS UI including hidden content to identify whether any one of the OFSAs are selected;
generate a modified OIS UI comprising at least one clearly visible option for bypassing a selection of the request for action; and
render and present the modified OIS UI on the display to inform a user and enable an option for moving past the OIS UI without completing the request for action.

2. The electronic device of claim 1, wherein to generate the modified OIS UI, the processor is configured to cause the electronic device to present, within the modified OIS UI, one or more of (i) a selectable option to skip or decline-all and not select any of the OFSAs, (ii) a condensed listing of which OFSAs are currently selected, and (iii) additional descriptive information that provides an explanation of OFSAs that are currently selected and an effect of selecting the request for action.

3. The electronic device of claim 2, wherein to generate the modified OIS UI, the processor is further configured to cause the electronic device to present, within the modified OIS UI, one or more of (i) updated information overlaying originally presented information, (ii) previously hidden or collapsed sections of the OIS UI, and (iii) the at least one pre-selected OFSAs unselected.

4. The electronic device of claim 1, wherein the processor is further configured to cause the electronic device to:
determine whether one or more characteristic associated with the request for action or at least one of the selected OFSAs is inconsistent with at least one safeguard standard from among a group comprising of (i) user preferences, (ii) peer user inputs, and (iii) policy compliance requirements; and
in response to determining that the one or more characteristic is inconsistent with the at least one safeguard standard, perform one or more modifications from a group comprising (i) visibly presenting an explanation of the OFSAs that are currently selected and an effect of selecting the request for action with the OFSAs selected, (ii) overlaying originally presented information with updated information, (iii) adding a selectable option to skip or decline-all and not select any of the pre-selected OFSAs, (iv) unhiding collapsed or hidden sections of the OIS UI, and (v) dynamically unselecting the at least one pre-selected OFSAs.

5. The electronic device of claim 4, wherein the processor is further configured to cause the electronic device to:
determine a risk score corresponding to the one or more characteristic being inconsistent with the at least one safeguard standard;
in response to determining the risk score is at or below a first risk threshold, maintain an original presentation format of the OIS UI, wherein the OIS UI is not modified;
in response to determining the risk score is above the first risk threshold, trigger the modifying of the OIS UI.

6. The electronic device of claim 5, wherein the processor is further configured to cause the electronic device to:
in response to the risk score being above the first risk threshold, determine whether the risk score is below a second risk threshold that is higher than the first risk threshold;
in response to determining the risk score is below the second risk threshold, modify the OIS UI by performing one or more modifications from a group comprising visibly presenting an explanation of the OFSAs that are currently selected and an effect of selecting the request for action with the OFSAs selected, overlaying originally presented information with updated information, and adding a selectable option to skip or decline-all and not select any of the pre-selected OFSAs; and
in response to determining the risk score is at or above the second risk threshold, modify the OIS UI by performing modifications from a group comprising modifying the request for action, unhiding collapsed or hidden sections of the OIS UI, and dynamically unselecting the at least one pre-selected OFSAs.

7. The electronic device of claim 1, wherein the processor is further configured to cause the electronic device to analyze all content of the OIS UI including hidden content to identify whether any one of the OFSAs includes deceptive language by utilizing an AI engine to perform one or more actions from a group comprising (i) natural language processing (NLP) analysis, (ii) contextual analysis, and (iii) semantic analysis.

8. The electronic device of claim 1, wherein the processor is further configured to cause the electronic device to analyze all content of the OIS UI including hidden content to identify whether any one of the OFSAs are selected by utilizing an AI engine to implementing one or more actions from a group comprising of (i) screen parsing and optical character recognition (OCR), (ii) pattern recognition, (iii) permission monitoring, and (iv) device level accessibility service.

9. The electronic device of claim 1, wherein the processor is further configured to cause the electronic device to:
retrieve feedback data collected from other users based on experiences of the other users interacting with one or more of the OFSAs; and
determine whether the one or more characteristic include factors that are known to be deceiving based on the feedback data collected from the other users.

10. The electronic device of claim 4, wherein the processor is further configured to cause the electronic device to:
determine, using an artificial intelligence (AI) engine, whether the information presented by the one or more characteristics includes information that is inconsistent with the safeguard standard, the AI engine trained to use at least aggregated data and insights related to user preferences, historical actions responsive to requests for actions, historical deceptive behavior included in the requests for actions, and relevant policy compliance requirements.

11. The electronic device of claim 10, wherein the processor is further configured to cause the electronic device to:
determine, using the AI engine, whether the request for action or the at least one of the selected OFSAs is presented in to mislead or confuse the user into accepting the request for action or the at least one of the selected OFSAs, the AI engine trained to use the at least aggregated data and insights related to user preferences, the historical actions responsive to requests for actions, the historical deceptive behavior included in requests for actions, and the relevant policy compliance requirements; and
in response to the AI engine determining that there is indication of deceptive manner, generate a trigger to cause the OIS UI to be modified to reveal or remove the deception or enable user bypass of the request for action.

12. A method comprising:
detecting user engagement with one or more opt-in selection (OIS) user interfaces (UI) presenting at least one selectable choice for opting in to specific optional features, services, and/or applications (OFSAs);
in response to detecting a request for action within the OIS UI that triggers automatic selection of at least one of the specific OFSAs:
analyzing all content of the OIS UI including hidden content to identify whether any one of the OFSAs are selected;
generating a modified OIS UI comprising at least one clearly visible option for bypassing a selection of the request for action; and
rendering and presenting the modified OIS UI on the display to inform a user and enable an option for moving past the OIS UI without completing the request for action.

13. The method of claim 12, wherein generating the modified OIS UI comprises presenting, within the modified OIS UI, one or more of (i) a selectable option to skip or decline-all and not select any of the OFSAs, (ii) a condensed listing of which OFSAs are currently selected, and (iii) additional descriptive information that provides an explanation of OFSAs that are currently selected and an effect of selecting the request for action.

14. The method of claim 13, wherein generating the modified OIS UI, further comprises presenting, within the modified OIS UI, one or more of (i) updated information overlaying originally presented information, (ii) previously hidden or collapsed sections of the OIS UI, and (iii) the at least one pre-selected OFSAs unselected.

15. The method of claim 12, further comprising:
determining whether one or more characteristic associated with the request for action or at least one of the selected OFSAs is inconsistent with at least one safeguard standard from among a group comprising of (i) user preferences, (ii) peer user inputs, and (iii) policy compliance requirements; and
in response to determining that the one or more characteristic is inconsistent with the at least one safeguard standard, performing one or more modifications from a group comprising (i) visibly presenting an explanation of the OFSAs that are currently selected and an effect of selecting the request for action with the OFSAs selected, (ii) overlaying originally presented information with updated information, (iii) adding a selectable option to skip or decline-all and not select any of the pre-selected OFSAs, (iv) unhiding collapsed or hidden sections of the OIS UI, and (v) dynamically unselecting the at least one pre-selected OFSAs.

16. The method of claim 15, further comprising:
determining a risk score corresponding to the one or more characteristic being inconsistent with the at least one safeguard standard;
in response to determining the risk score is at or below a first risk threshold, maintaining an original presentation format of the OIS UI, wherein the OIS UI is not modified;
in response to determining the risk score is above the first risk threshold, triggering the modifying of the OIS UI.

17. The method of claim 16, further comprising:
in response to the risk score being above the first risk threshold, determining whether the risk score is below a second risk threshold that is higher than the first risk threshold;
in response to determining the risk score is below the second risk threshold, modifying the OIS UI by performing one or more modifications from a group comprising visibly presenting an explanation of the OFSAs that are currently selected and an effect of selecting the request for action with the OFSAs selected, overlaying originally presented information with updated information, and adding a selectable option to skip or decline-all and not select any of the pre-selected OFSAs; and
in response to determining the risk score is at or above the second risk threshold, modifying the OIS UI by performing modifications from a group comprising modifying the request for action, unhiding collapsed or hidden sections of the OIS UI, and dynamically unselecting the at least one pre-selected OFSAs.

18. The method of claim 12, further comprising:
analyzing all content of the OIS UI including hidden content to identify whether any one of the OFSAs includes deceptive language by utilizing an AI engine to perform one or more actions from a group comprising (i) natural language processing (NLP) analysis, (ii) contextual analysis, and (iii) semantic analysis.

19. The method of claim 12, further comprising:
analyzing all content of the OIS UI including hidden content to identify whether any one of the OFSAs are selected by utilizing an AI engine to implementing one or more actions from a group comprising of (i) screen parsing and optical character recognition (OCR), (ii) pattern recognition, (iii) permission monitoring, and (iv) device level accessibility service.

20. A computer program product comprising:
a computer readable storage device; and
program code on the computer readable storage device that when executed by a processor associated with an electronic device, the program code is configured to cause the electronic device to provide functionality of:
detecting user engagement with one or more opt-in selection (OIS) user interfaces (UI) presenting at least one selectable choice for opting in to specific optional features, services, and/or applications (OFSAs);
in response to detecting a request for action within the OIS UI that triggers automatic selection of at least one of the specific OFSAs:
analyzing all content of the OIS UI including hidden content to identify whether any one of the OFSAs are selected;
generating a modified OIS UI comprising at least one clearly visible option for bypassing a selection of the request for action; and
rendering and presenting the modified OIS UI on the display to inform a user and enable an option for moving past the OIS UI without completing the request for action.
